(19) United States
(12) Patent Application Publication
(10) Pub. No.: US 2018/0303080 A1
(43) Pub. Date: Oct. 25, 2018

(54) APPARATUS FOR CATCHING INSECTS

(71) Applicant: Jeremy Shasha, Studio City, CA (US)

(72) Inventor: Jeremy Shasha, Studio City, CA (US)

(21) Appl. No.: 15/958,782

(22) Filed: Apr. 20, 2018

Related U.S. Application Data
(60) Provisional application No. 62/487,754, filed on Apr. 20, 2017.
(60) Provisional application No. 62/586,840, filed on Nov. 15, 2017.

(51) Int. Cl. A01M 3/04; A01M 1/10; A01M 1/14

(52) U.S. Cl. CPC A01M 3/04; A01M 1/103; A01M 2200/012; A01M 1/106; A01M 2200/011; A01M 1/14

(57) ABSTRACT

Provided is an apparatus for catching insects, comprising: a) a body; b) a cover at least over a portion of the body; and c) a handle attached to the body; wherein a user holds the apparatus with the handle and presses the cover against the insect. The cover can be a bag. The apparatus can further comprise a substance placed on a surface of the bag for contacting the insect, wherein the substance increases adhesivity of the surface of the bag for the insect. The substance can be a gel. Also provided are methods of catching insects with the apparatus.

### CROSS-REFERENCE

The present application claims the benefit of U.S. Appl. No. 62/487,754, filed on Apr. 20, 2017, and U.S. Appl. No. 62/586,840, filed on Nov. 15, 2017, which are incorporated herein by reference in its entirety.

### BACKGROUND SECTION OF THE INVENTION

There are tools available for killing/catching insects, particularly indoors, such as swatters. The problem with traditional insect catchers is that they are only useful in certain situations. Insect catchers may not be disposable, and may not provide the option of catching the insect without killing the insect. Some insect catchers only allow insects to be caught in certain angles, usually 180 degrees, or straight ahead. Many insect catchers are not long enough and require the user to stand on a chair or furniture to reach the insect. Additionally insect catchers do not provide a manner to dispose the insect and can become contaminated with insect parts/blood after killing the insect. There is a need in the art for an apparatus for catching insects that solves the above mentioned problems.

### SUMMARY SECTION OF THE INVENTION

Provided is an apparatus for catching insects, comprising: a) a body; b) a cover at least over a portion of the body; and c) a handle attached to the body; wherein a user holds the apparatus with the handle and presses the cover against the insect. The cover can be a bag. The apparatus can further comprise a substance placed on a surface of the bag for contacting the insect, wherein the substance increases adhesivity of the surface of the bag for the insect. The substance can be a gel. The bag can have an inside-out and an outside-out configuration, with contact being made with the insect in the inside-out configuration, and the insect contained by changing the bag's configuration to an outside-out configuration. The bag can have an original outside-out configuration before use and the bag further comprised a substance placed inside of the bag in the original configuration to increase adhesivity of a surface of the bag to the insect. The bag can have an original outside-out configuration before use and the bag has an adhesive on the outside before use, for attachment to the body. The apparatus can further comprise an adhesive on the bag for removably attaching the bag to the body. The apparatus can further comprise a double sided tape for attaching the bag to the body. The bag can be removably attached to the body. The bag can further comprise a zipper. The bag can further comprise a container with a gel, wherein the gel is applied to the bag by a user. The body can be made from a compressible material that is compressed when the apparatus is pressed against a surface.

Provided is an apparatus for catching insects, comprising: a) a body; b) a first bag, attached to the body; c) a handle attached to the body; d) a second bag for catching an insect e) a layer in between the first and the second bag for keeping the first bag and second bag removably together; wherein a user holds the apparatus with the handle and presses the bag against the insect to contain the insect with the second bag.

Provided is a method for catching an insect, comprising: a) holding an apparatus with a handle and a compressible material; and b) pressing the compressible material on a surface having an insect thereon.

Provided is a method for catching an insect, comprising: a) removably attaching a bag to a body with a handle; b) pressing the bag against the insect while holding the handle. The method can further comprise the step of turning, the bag inside-out before pressing the insect. The method can further comprise the step of turning the bag outside-out to contain the insect. The method can further comprise the step of adding a substance to increase adhesiveness to a surface of the bag contacting the insect. The substance is a gel. The method can further comprise the step of attaching the bag to the body with an adhesive. The adhesive can be in form of a double sided tape. The method can further comprise the step of removing the insect from the bag. The body can compress when pressed the bag against the insect.

### BRIEF DESCRIPTION OF THE FIGURES

FIG. 1 illustrates an apparatus for capturing insects laving a handle and a soft material without pre-applied gel.

FIG. 2 illustrates an apparatus for capturing insects having a handle and a soft material with pre-applied gel.

FIG. 3A illustrates a bag attached in an inside-out fashion to the body of the apparatus.

FIG. 3B illustrates the bag of FIG. 3A with gel applied thereto.

FIG. 3C illustrates the apparatus of FIG. 3B pressed against a surface, and one or more insects attached to the gel.

FIG. 4A illustrates turning the bag outside-out.

FIG. 4B illustrates sealing the bag with insects therein.

FIG. 4C illustrates the bag with the insect after detached from the body.

FIG. 5 illustrates an apparatus with a fillable soft material and multiple bags.

FIG. 6 illustrates the layers of the apparatus for consecutive uses without having to reapply a bag on the apparatus.

FIG. 7 illustrates the layers of the apparatus for consecutive uses without having to reapply a bag on the apparatus.

### DETAILED DESCRIPTION OF THE INVENTION

Provided is an apparatus for capturing an insect. Examples of insects include common insects found at home or in buildings, including spiders, roaches, beetles, ants, bees, and flies. The apparatus can be used indoors or outdoors. Typical places include homes, office buildings, tents, and motorhomes.

The apparatus allows for capturing the insects live in a humane fashion, and the subsequent release of the insect. Alternatively a user can use the apparatus in such fashion to kill and dispose of the insect. The entire apparatus is disposable and can be thrown away, and is also reusable and can be used on multiple occasions.

The apparatus can include a handle 1, typically a rod in form of a stick of wood or another material, such as plastic. Handle 1 an also be telescopic, hinged, and/or foldable.

At one end of the handle 1, there can be placed a body 2 having an optionally compressible/depressible material 3, such as foam, wool, or polyester fiber (cotton or other types of wool). The body 2 can be attached to the end of the handle 1. When the compressible material is form 3, a hole can be made in the material to place the handle 1.

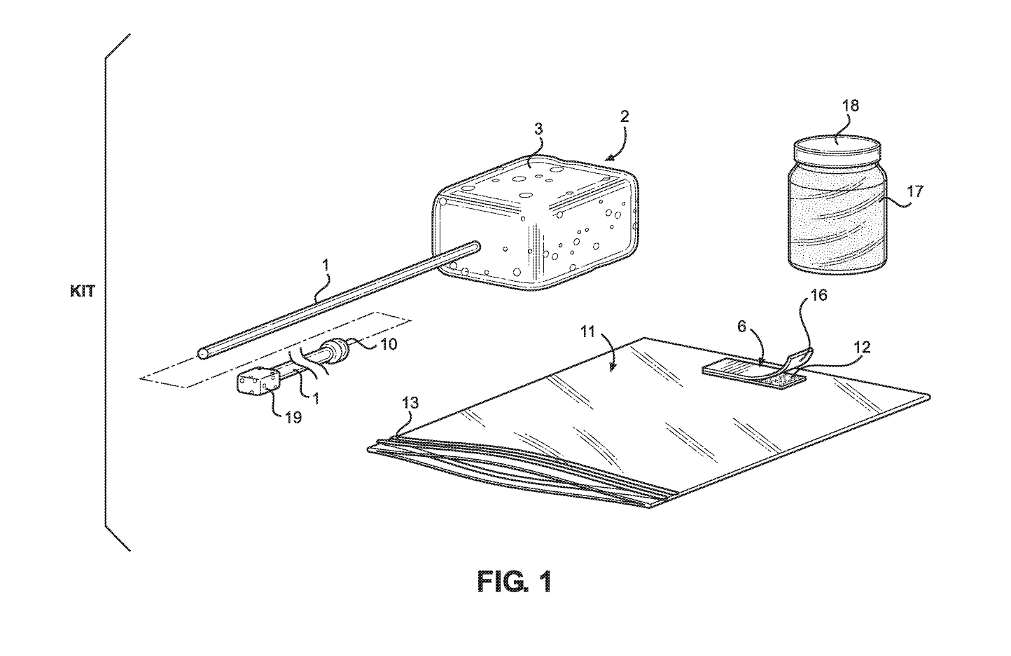

As illustrated in FIG. 1, a body 2 in a shape of a cuboid is attached to one end of handle 1. The body 2 can have an opening (typically a slit made by a razor) for placing inside one end of the handle 1. An adhesive (not illustrated) can be used to attach the handle 1 to the body 2. The body 2 can also have other shapes, such as spherical, cylindrical, triangular, or trapezoidal. The insect catcher can come in a kit with a container for a substance that increases adhesivity, such as a gel 14. The container 17 can have a removable cap 18. The container 17 can be squeezable, with a cap 18 having an opening that allows gel 14 to come out of the container 17 when squeezed. The kit can also come with a removable cover, such as bag 7 for the body 2. As illustrated in FIG. 1, the cover is a bag 11 with a zipper 13. FIG. 1 also illustrates the optional connector 10 for removably attaching a handle extension. Each handle 1 can be approximately one foot long (10-12 inches) for a total of two feet. The handle 1 can be located in the opposite side of the apparatus as the body 2, the bag 7. The gel 14 can be appllied to any side of body 2, including top and/or one or more sides. On the other end of the handle 1, another body 19 made from a material (such as a compressible or non-compressible material) or even a feather can be placed to make the insect move to easier spot before capture.

FIG. 1 also illustrates an adhesive 12 on the cover, in this case the bag 11. The adhesive 12 can be part of a double sided tape, with one side of the tape attached to the bag 11 and the other side having a removable peel 16. The removable peel 16 can be removed to expose adhesive 12 so to attach the cover (bag) 11 to the body 2.

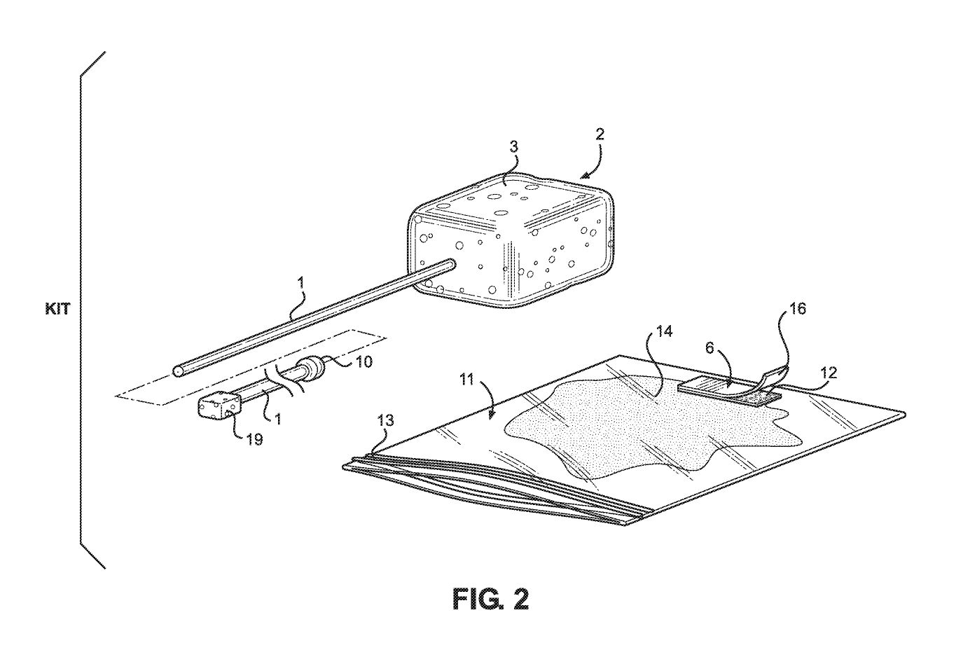

FIG. 2 illustrates another embodiment similar to FIG. 1. In this embodiment, the adhesivity substance 14 is placed inside of the cover (illustrated as a bag) 11 beforehand, and a separate container is not provided. Depending on the substance 14, the bag 11 may have to be sealed.

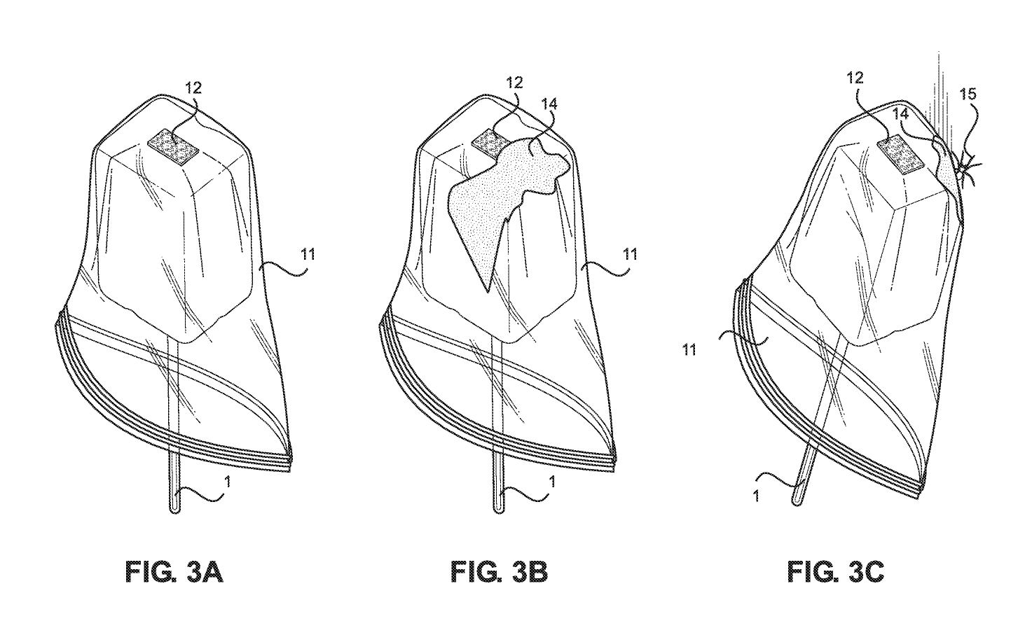

FIGS. 3A-C illustrate when the cover, in this ease the bag 11 is positioned inside-out over the body 2. The peel 16 of the double sided tape has been removed, and the bag is attached through the adhesive 12 on the tape to the body 2. In FIG. 3A, the gel (or similar substance) has not been placed on the bag. In FIG. 3B, the gel 14 has been placed on the bag 11. The placement of the gel 14 can be by a user taking the container 17 and putting gel 14 on the bag 11, or the gel 14 can be pre-applied (illustrated in FIG. 2) in the bag 11. The bag 11 may have to be sealed if the gel 14 is pre-applied. FIG. 3C illustrates insects 15, in this case, a spider, attached to the gel 14. FIG. 3C illustrates the body 2 getting compressed by being pressed against a surface, such as a wall.

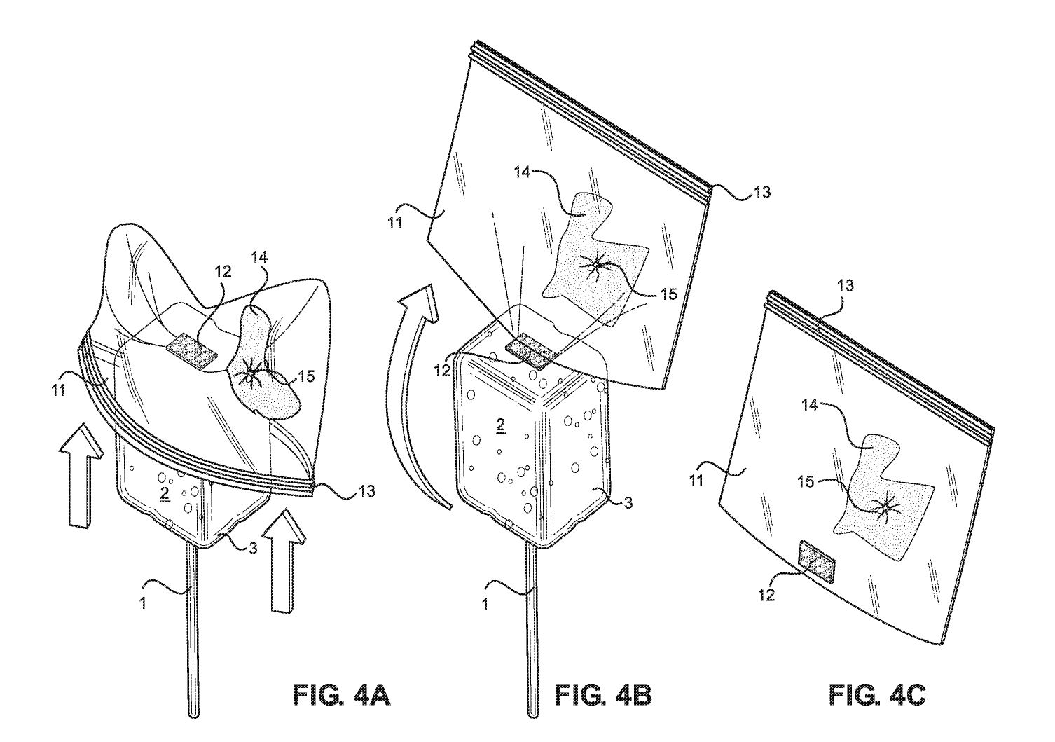

FIGS. 4A and 4B illustrate disposing of the insect(s) 15 after an insect 15 has been caught. In the FIG. 4A, the bag 11 is moved from an inside-out to outside-out position (original position), with the insect 15 in the bag 11. FIG. 4B illustrates optionally sealing the bag 11. In this case, the bag 11 is sealed with the zipper 13. FIG. 4C illustrates the bag 11 with the insect 15 after it has been removed from body 2.

In another embodiment, an adhesive is not used to attach the bag 11 to the body 2. The bag 11 can be configured to be the right size, such as sufficiently tight and/or long, to be able to be rolled from inside-out to outside-out without the need for attachment with an adhesive 12 (or another adhesive) to body 2. Alternatively, the adhesive could be applied as a permanent layer on the bag, such as a pressure sensitive adhesive (Post-It® Note).

FIG. 7 illustrates another embodiment of the kit where multiple layers of bags 11 are pre-placed on the body 2, allowing the user to use the apparatus multiple times and not needing to put bags 11 on the body 2 after each use. The bags 11 can already be in an inside-out configuration. The multiple layers can include an intervening layer of tape 6 for removably attaching one bag 11 to another. The adhesive 12 on tape 6 can also be used to catch an insect 15.

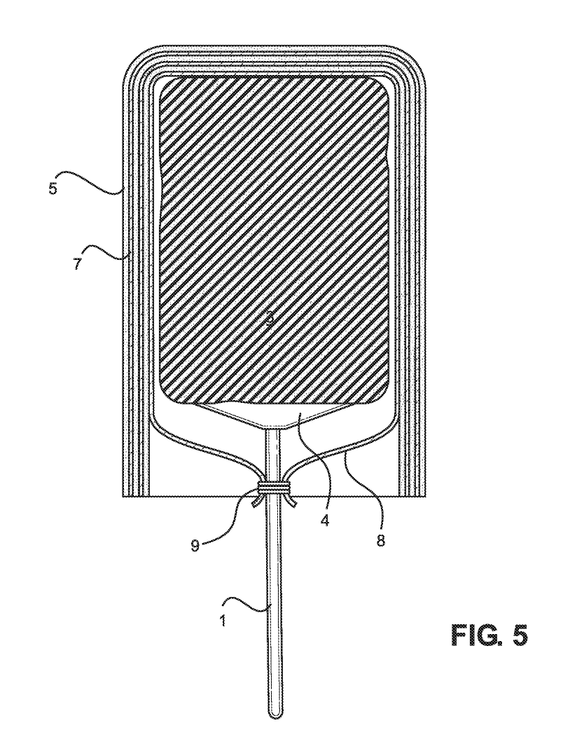

FIG. 5 illustrates another embodiment of the insect catcher. This embodiment can also come with pre-placed bags 11. The compressible material illustrated in this embodiment is a fillable polyester material, rather than a foam or solid material. Optional connector 4 is attached to the compressible material 3 with or without an adhesive. Container bag 8 is placed with a rubber band 9 to cover soft material 3 to maintain the fillable material. Instead of a rubber band 9, an adhesive can also be used. Another bag 7 is placed on top of the container bag 8. Typically both bags have a smooth surface, and an adhesive, tape, or a plastic wrap needs to be placed in between them to stabilize an assembly of layers of the bags 7,8.

For fillable compressible material 3 such as cotton wool or polyester fiber fillers, the material can be attached to the optional connector 4 at end of the handle 1. The connector 4 can have an opening for attachment to the handle 1 and one or more arms that can hold the compressible material 3, such as with the use of an adhesive. The compressible material 3 functions to cushion the impact on the insect 15 in the event the user wants to keep the insect 15 alive and release the insect 15. The connector 4 can be open faced at the top to provide stability to the compressible material 3 when compressed. The connector 4 and handle 1 can be fabricated as a single piece or separate pieces. In another embodiment, a handle 1 is used without connector 4.

Compressible means that the material when pressed with a force of 1 pound with a circular flat surface having a diameter of 1 cm in opposite direction and the same plane and direction (from one line) as the handle 1, the material depresses at the center of the circle at least 0.5 cm. Hard surface means that a compression of less than 0.2 cm happens. A person can apply less pressure to keep the insect alive.

The adhesivity substance can include viscous materials such as gels, adhesives, and glue. The viscosity (centipoises) can be 50 to 200,000 such as 50 to 70,000 (centipoises 70° F. Standard pressure). To keep the substance 14 from drying out, either the substance can be placed in a sealed bag 7 or a plastic wrap 5 that is substantially impermeable to air is placed on top of the bag 7, so that the substance is in between the bag 7 and plastic wrap 5. Plastic wrap 5 can be Kirkland Stretch-Tite®, SARAN WRAP, which is a thin clingy sheet of plastic made from Polyvinylidene Chloride (PVC) or Low-Density Polyethylene (LDPE). Alternatively a zipper bag 11 with a reclosable zipper 13, can be used to keep the substance 14 from drying out so that there is no need for a plastic wrap 5.

The bag 7 or zipper bag 11 can be made from one or more sheets of plastic such as high density polyethylene or HDPE or low density polyethylene or LDPE. The bag 7 or 11 typically has a smooth non-clingy texture that allows it to be turned inside-out easily. The bag 7 or 11 is typically thicker than the plastic wrap 5.

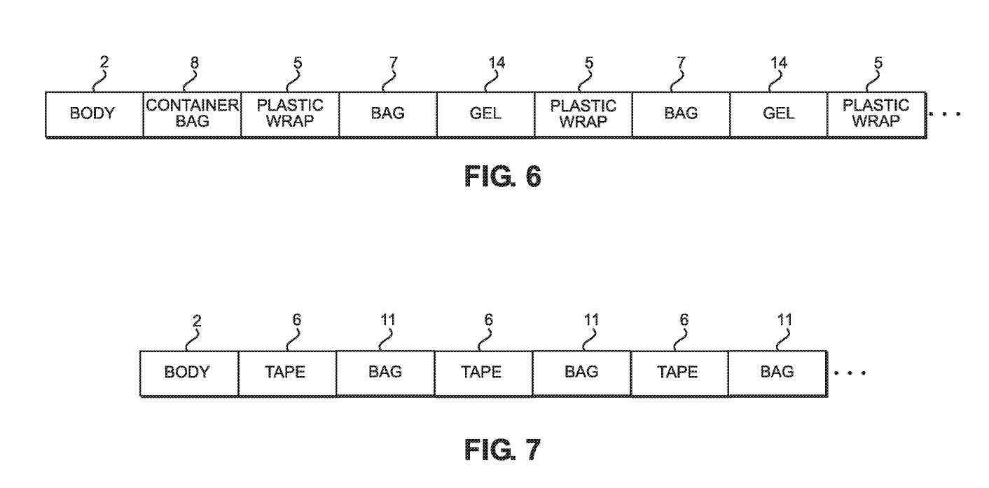

The apparatus can be made for consecutive uses without the need to re-apply a bag 7 or 11. Multiple layers of the bag-gel-plastic or multiple layers of the bag-adhesive (tape) can be used (the gel 14 is not illustrated in FIG. 5). As illustrated in FIG. 6, the apparatus can have layers of (from outside) plastic wrap-gel-bag-wrap-gel-bag-wrap-gel-bag. The clingy nature of the plastic wrap 5 provides some stability to the bag and also allows the bag to be flipped back to an outside-out position without the need of an adhesive such as adhesive 12. Alternatively, if plastic wrap 5 is not used, another adhesive 12, such as double sided tape, can be used to stick the outside of the bag 7 or zipper bag 11 to the outside of bag 8 to allow the bag to be rolled up easily. The adhesive 6 is typically placed on the bag 7 in an area that is in front of the end of the body 2. In another embodiment, a zipper bag 11, with a resealable zipper 13, an adhesive 6 on the inside and an adhesive (such as double sided tape) 12 on the outside can be placed on top of the apparatus individually each time the apparatus is to be used.

Depending on the insect catcher, the user takes different steps to catch the insect 15. If the user has the kit of FIG. 1, the user removes the peel 16 of the tape 6, attaches the exposed adhesive 12 on the tape 6 to the body 2, and then turns the bag 11 inside out over the body 2. The user then applies an adhesivity substance, such as the gel 14 to the bag. The user would squeeze the container 17 and have the gel 14 be applied to the surface of the bag 11. The user can smooth out the gel 14 over the bag 11 with a linger if needed. The gel 14 can be applied anywhere on the bag 11, including the sides. The user would then hold the apparatus with the handle 1 and press the apparatus against a surface having an insect 15. The body 2 of the apparatus may compress when pressed against the surface. After catching the insect 15, the user can shake or scrape the bag/apparatus to remove the insect 15, or alternatively roll the bag 11 into an outside-out position and optionally seal the bag 11 with the insect 15 inside. The user can also release the insect 15 from captivity by shaking the apparatus or unsealing the bag 11. If the kit of FIG. 2 is used, the user does not need to apply the gel 14 since the gel 14 is pre-applied.

If the user is using the catcher of FIG. 5, the user removes the plastic wrap 5, exposing the gel 14 on the bag 7. The user then, holding the handle 1, touches the portion of the bag 7 having the gel 14 to the insect 15. The user can push the bag 7 against the insect 15 as much as desired by the user. The less force the user applies, the less likely that the insect 15 is killed. The layers of the bag/cover 7, and the optional compressible material 3 allows for cushioning the force against the insect 15 to avoid crushing the insect 15. After capturing the insect 15 on the substance 14, the user rolls the bag 7 from an inside-out position to outside-out position with the insect 15 inside. The user can then seal the bag 7, for example with the tabs, or close the zipper 13 of bag 11. The bag 7 can then be discarded with the insect 15 or the insect can be freed by the user. Alternatively, the user may not roll up the bag, and can release the insect 15 by shaking the apparatus to free the insect 15 from adhesive 6.

FIGS. 6 and 7 illustrate multi-use apparatuses without the need to place a bag after each time an insect is captured. Any of the insect catchers described above can be configured for multiple use with pre-placed bags. Multiple bags 7 or 11 for catching the insect 15 can be placed on the body 2. The bags 7 or 11 can be attached to each other with an adhesive such as tape 6, where the user would apply gel 14 to the bag 7 or 11 that is exposed (FIG. 7). A adhesive sensitive adhesive like that on Post-It® notes can also be placed directly on the bag. Alternatively, the gel 14 can be placed beforehand as illustrated in FIG. 6. In this embodiment, a plastic wrap 5 can be used to keep the gel 14 from evaporating and to stabilize the bag 7 or 11.

### 1. Handle

### 2. Body

3. Compressible material

### 4. Connector

5. Plastic wrap

### 6. Tape

7. Cover (illustrated as a bag)
8. Bag (to contain compressible material)
9. Rubber band
10. Connector (for two handles)

### 11. Zipper bag

12. Adhesive

### 13. Zipper

14. Substance that increases adhesivity (illustrated as a gel).

### 15. Insect

### 16. Peel

### 17. Container

### 18. Cap

### 19. Body

What is claimed is:

1. An apparatus for catching insects, comprising:
a) a body;
b) a cover at least over a portion of the body. and
c) a handle attached to the body;
wherein a user holds the apparatus with the handle and presses the cover against the insect.

2. The apparatus of claim 1, wherein the cover is a bag.

3. The apparatus of claim 2, further comprising a substance placed on a surface of the bag for contacting the insect, wherein the substance increases adhesivity of the surface of the bag for the insect.

4. The apparatus of claim 3, wherein the substance is a gel.

5. The apparatus of claim 2, wherein the bag has an inside-out and an outside-out configuration, with contact being made with the insect in the inside-out configuration, and the insect contained by changing the bag's configuration to an outside-out configuration.

6. The apparatus of claim 5, wherein the bag has an original outside-out configuration before use and the bag further comprised a substance placed inside of the bag in the original configuration to increase adhesivity of a surface of the bag to the insect.

7. The apparatus of claim 1, further comprising an adhesive on the cover for removably attaching the cover to the body.

8. The apparatus of claim 2, further comprising an adhesive for attaching the bag to the body.

9. The apparatus of claim 2, wherein the bag is removably attached to the body.

10. The apparatus of claim 2, further comprising a zipper on the bag.

11. The apparatus of claim 2, further comprising a container with a gel, wherein the gel is applied to the bag by a user.

12. The apparatus of claim 2, wherein the body is made from a compressible material that is compressed when the apparatus is pressed against a surface.

13. A method for catching an insect, comprising:
a) holding an apparatus with a handle and a compressible material; and
b) pressing the compressible material on a surface having an insect thereon.

14. A method for catching an insect, comprising:
a) removably attaching it bag to a body with a handle;
b) pressing the bag against the insect while holding the handle.

15. The method of claim 14, further comprising the step of turning the bag inside-out before pressing the insect.

16. The method of claim 15, further comprising the step of turning the bag outside-out to contain the insect.

17. The method of claim 14, further comprising the step of adding a substance to increase adhesiveness to a surface of the bag contacting the insect.

18. The method of claim 17, wherein the substance is a gel.

19. The method of claim 14, further comprising the step of removing the insect from the bag.

20. The method of claim 14, wherein the body compresses when pressing the bag against the insect.
